(19) United States
(12) Patent Application Publication
(10) Pub. No.: US 2018/0158109 A1
(43) Pub. Date: Jun. 7, 2018

(54) SCALING PERSONA TARGETED ADVERTISEMENTS

(71) Applicant: 140 Proof, Inc., San Francisco, CA (US)

(72) Inventors: John Manoogian, III, San Francisco, CA (US); Jon Elvekrog, San Francisco, CA (US)

(21) Appl. No.: 15/820,710

(22) Filed: Nov. 22, 2017

Related U.S. Application Data
(63) Continuation of application No. 15/096,914, filed on Apr. 12, 2016, now abandoned.
Application No. 15/096,914 is a continuation of application No. 14/187,966, filed on Feb. 24, 2014, now abandoned.
Application No. 14/187,966 is a continuation of application No. 13/113,893, filed on May 23, 2011, now abandoned.
(60) Provisional application No. 61/347,773, filed on May 24, 2010.

(51) Int. Cl. G06Q 30/02; G06Q 50/00

(52) U.S. Cl. CPC G06Q 30/0269; G06Q 30/0251; G06Q 50/01; G06Q 30/0256; G06Q 30/0257

(57) ABSTRACT

One embodiment of the invention includes a method for allocating an advertisement to a plurality of users within a social network ecosystem, wherein each user is associated with a user summary comprising a keyword describing a user attribute extracted from the social network, the method including the steps of selecting a user audience for each of the plurality of advertisements from the plurality of users by altering the advertisement summary based on the target audience and an audience restriction, associating the advertisement with each user of the user audience, prioritizing each the advertisement list of each user, and serving an advertisement to the user in response to an advertisement request for the user.

### CROSS-REFERENCE TO RELATED APPLICATIONS

This application is a continuation of U.S. application No. 15/096,914, filed 12-Apr.-2016, which is a continuation of U.S. application No. 14/187,966, filed 24-Feb.-2014, which is a continuation of U.S. application No. 13/113,893, filed 23-May-2011, which claims the benefit of U.S. Provisional Application No. 61/347,773, filed 24-May-2010, all of which are incorporated in their entirety by this reference.

### TECHNICAL FIELD

This invention relates generally to the digital advertising field, and more specifically to a new and useful method and system for scaling persona targeted advertisements in the digital advertising field.

### BACKGROUND

Advertising search engine optimization on the internet has been mostly dominated by technologies based on keywords. Crafting a list of keywords to capture the right audience is important to advertisers. The keywords essentially rely on people accessing particular content to have a particular interest in that content. As websites grow more social and content is produced in more of a content stream such as Twitter, the Facebook Feed, Google Buzz, Flickr, etc. more information about people is available. Targeting a particular person or type of person, however, has many challenges. Building a descriptor of a target audience requires a tremendous amount of insight into audience populations by an advertiser. Thus, there is a need in the digital advertising field to create a new and useful method and system for scaling persona targeted advertising. This invention provides such a new and useful method and system.

### BRIEF DESCRIPTION OF THE FIGURES

FIG. 1 is a schematic representation of a method of a preferred embodiment of the invention.

FIG. 2 is a schematic representation of a system of a preferred embodiment of the invention.

FIG. 3 is a schematic representation of advertisement summary adjustment based on the target audience size and an audience restriction.

FIG. 4 is a detailed representation of an exemplary schedule planner.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. Method for Scaling Persona Targeted Advertisements

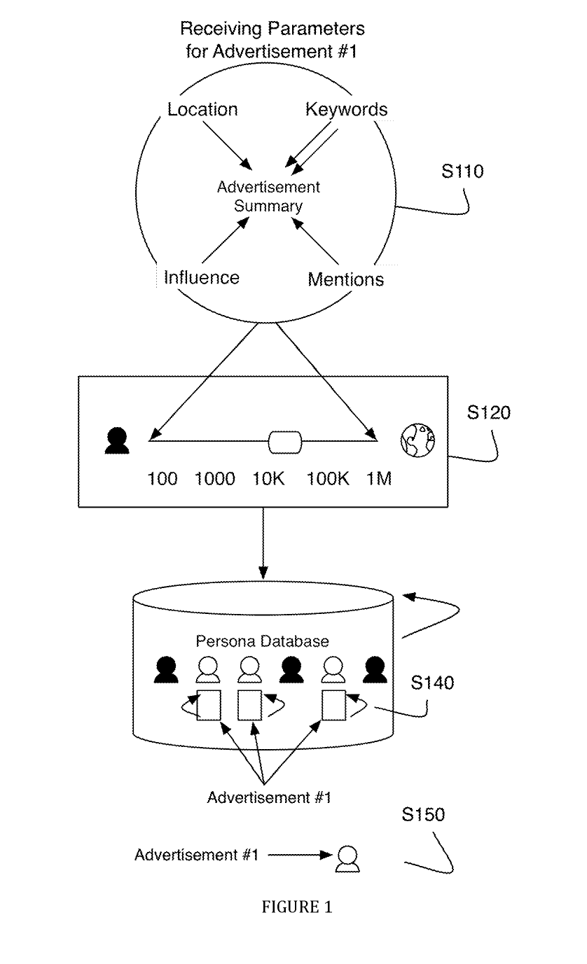

As shown in FIG. 1, a method for allocating user impressions to a plurality of advertisements includes receiving an advertisement summary S110, receiving a target audience size S120, selecting a user audience based on the target audience size S130, assigning and prioritizing the advertisement for a user of the user audience S140, and serving a user-associated advertisement to the user S150. The method enables content providers and/or advertising agencies to not only determine the ideal attributes for a target audience when given a target audience size and a basic audience description, but also to determine the best allocation of limited user impressions amongst multiple advertisements. The method is preferably used to serve advertisements by prioritizing and serving advertisements that satisfy both the advertisers' requirements (as determined by the basic audience description and the target audience size) and the users preferences (as determined by the user summary). The method may additionally provide feedback to advertisers on the projected number of advertisement views or impressions based on the targeting criteria. The method may additionally be used for planning a dynamic campaign that can be set to adjust target audiences over time. The method is preferably used for digital advertising, and more preferably in combination with a social network with a content stream such as Twitter, Facebook Feed, Google Buzz, Flickr, micro blogging sites, or any suitable social network. Social networks and/or content stream based websites preferably include content that is conducive for generating personas of users. The personas are preferably generalizations of the interests, behavior, demographics and any suitable characteristic of users. The method may additionally be used for advertising on a website where persona information can be linked to the website. The method may alternatively be used in any suitable manner.

The method is preferably used with a database of user summaries. These user summaries are preferably created to generate a user data representation or descriptor from the perceived interests and characteristics of the user. The user summary is preferably extracted from implicit persona attributes of a user account and more preferably a content stream. Implicit persona attributes preferably describe characteristics that are apparent through the manner in which the social network is used by the user. A user summary preferably does not rely on the user being an active participant on the social network wherein an active participant describes user that creates content, rates content, interacts with content, and/or performs any suitable action. By having an account with social connections, the user preferably creates a social stream that is populated by content created by the social connections. The information contained within the whole of the social stream preferably includes implicit information from which characteristics of a user may be collected. The implicit information is preferably obtained through the content created by users that the user has decided to follow. The social stream of a user is preferably typically unique in that the user selects which users and entities to form a social network connection with or to follow. For example, a user following several professional baseball players may never actively state in the profile that the user has an interest in baseball, but extracting the implicit information from the user account would preferably indicate that baseball is an interest of the user. The user summary may additionally use explicit information such as content generated by the user or profile information such as location and interests. A large number of users preferably have user summaries in the database such that the method may be applied to a large population of users of a social network.

The user summary is preferably a collection of weighted keywords. The user summary may alternatively be any suitable data format such as a list of ratings for a standard set list of attributes for which any entity summary may be defined. A keyword is preferably a term or tag that is associated with or assigned to a central concept or piece of information. A group of terms may be associated with a single keyword. These terms preferably do not have to be derived from the same word root. The assignment of a term to a keyword may be algorithmically created or pre-assigned within the system. For example, the terms “Giants”, “golden gate bridge”, “Market St.” may be grouped with the keyword “San Francisco”. Canonical forms of words are preferably additionally recognized. For example, “NYTimes” and “New York Times” would be recognized as the same term and generate an instance of the same keyword. Terms or text may additionally be used to generate multiple keywords. From the earlier example, the term “Giants” may be used to generate an instance of the keyword “San Francisco” and “Baseball”. Keywords may additionally be hierarchical keywords where a keyword may have a parent concept, such as “San Francisco” and “California”. The keywords are preferably derived from content generated by the user and/or the content the user interacts with on a social network. In creating the user summary of weighted keywords, keywords are preferably first identified within content of the social network that the user has interacted with, based on grouping and priority rules keywords are assigned to the user summary, and then weighting is applied to keywords according to how strongly they correlate to, or are affiliated with, a user description (e.g., based on frequency of occurrence). More preferably, the keywords are derived from content of a social network stream. The social network stream may include content the user subscribes (i.e., follows) to and/or content generated by the user. In one variation, the user summary may include a plurality of vector parameters that cooperatively define characteristics of a user. Vectors are preferably different metrics of specifying aspects of user characteristics. Preferably, the vectors include keywords, location, followship (i.e., who the user follows and/or the type of entities the user follows), influence (i.e., number and/or type of followers or friends), mentions (i.e., the number of times the person is discussed by others), demographic, dislikes (e.g., concepts not of interest) and/or any suitable descriptor of a persona. A vector parameter is preferably the variable value for a particular vector. For example, a location vector may have a parameter of ‘San Francisco’ and an interest vector may have a parameter of ‘baseball’. Vectors such as influence may additionally weigh relationships between users. In one variation, the amount of interaction a user has with a second user or users may impact the influence vector of the user. For example, if two users message back and forth frequently then those two may share similar keywords. Additionally, personas may be created from multiple user summaries that are averaged or grouped together. These personas preferably comprise an importance-weighted list of keywords that describe a substantial number of users, preferably by the users' preferences, but alternately by any other vector (e.g. location, click-through habits, etc.).

Step S110, which includes receiving an advertisement summary, functions to collect an initial description of a target audience from an advertiser. An advertiser is preferably an entity that wishes to serve promotions to a user, but alternatively be a content provider or any party that wishes to feed targeted content to a user including promoted content, suggested social connections, media, or any suitable form of content. An advertisement summary is preferably a weighted list of keywords substantially similar to a user summary described above, wherein the keywords have an associated importance weight rather than an affiliation weight. The importance weighting is preferably applied to the keyword based on how important an advertiser deems the keyword to be. The importance weighting preferably influences how well a user summary must match the advertisement summary, but may alternately influence how much the keyword may be abstracted or narrowed. The importance weighting may also influence which keywords are added during the advertisement summary optimization. The advertisement summary may additionally include keyword affiliation weight selections for each of the included keywords. These affiliation weight selections are preferably accounted for when matching a user to an advertisement summary. Users with keyword affiliation weights higher than, or equal to, the keyword affiliation weight selection are preferably determined to match the advertisement summary. Similar to the user summary, the advertisement summary may alternatively be any suitable data format, such as a list of ratings for a standard set list of attributes for which any target persona may be defined. The user summary and advertisement summary preferably have similar formats. Preferably, the advertisement summary is preferably composed of a plurality of keyword parameters that cooperatively define targeted characteristics of an advertiser. The advertisement summary may be received in a variety of ways. As a first variation, the advertiser may select keywords that the advertiser wishes to target for content distribution. These keywords may be bid on by advertisers, and the importance weighting of words may additionally be selected by an advertiser. In a second variation the advertisement summary is preferably formed in substantially the same way as the user summary, by extracting keywords from a social network profile of the advertiser or alternatively from an outside web site. In this variation, the advertisement(s) of the advertiser may be used as the source for keyword extraction. In yet another variation, the advertiser may select a user that functions as prototype user for whom the advertiser wants to target. The advertiser may additionally select a plurality of prototype users. The user summaries of the plurality of prototype users are preferably merged to form a single advertisement summary. The prototype users may be real users or simulated users (fabricated as a model user the advertiser wishes to target). As an additional variation, the advertisement summary is preferably formed by analyzing the followers of an advertiser selected entity. The followers of the entity preferably describe users that have an interest in that entity. The entity may be the social network account of the advertiser, a product, a celebrity (such as a celebrity endorsing an advertised product), a club, or any suitable entity. In another variation, the advertisement summary is preferably selected from a set of predefined personas, wherein the persona is generated from groups of related users. Like the user summaries described above, these predefined personas preferably comprise a plurality of weighted keywords, The advertisement summary may be narrowly defined such that larger audiences can be abstracted from the information. For example, the base summary may be defined to described a persona that is a 28 year old male in San Francisco that has interests related to hiking, green initiatives, charities, building, energy drinks, organic food, and camping that has a following of 400 other users and is frequently mentioned. Such a persona may not match many people, but such an advertisement summary may be used to abstract to a larger audience in subsequent steps.

Step 120, which includes receiving a target audience size, functions to collect the desired audience size. This step is preferably performed by the content provider, but may alternately be performed by the advertiser, by an advertising agency, or by a processor. While the desired audience size is preferably calculated from a previous advertisement campaign, the target audience size may alternately be entered through a user interface. The user interface preferably provides input fields that receive the target audience size from the user. For example, a slider user interface tool may be used to indicate a desired audience audience of an audience scale. Setting the target audience size through the slider user interface preferably selects a set of vector parameters that substantially satisfy the target audience size requirements. The slider preferably scales from a small audience (more detailed) to a very large and detailed audience. Any alternative user interface may be used, such as a text field, a selectable menu, or any suitable user interface.

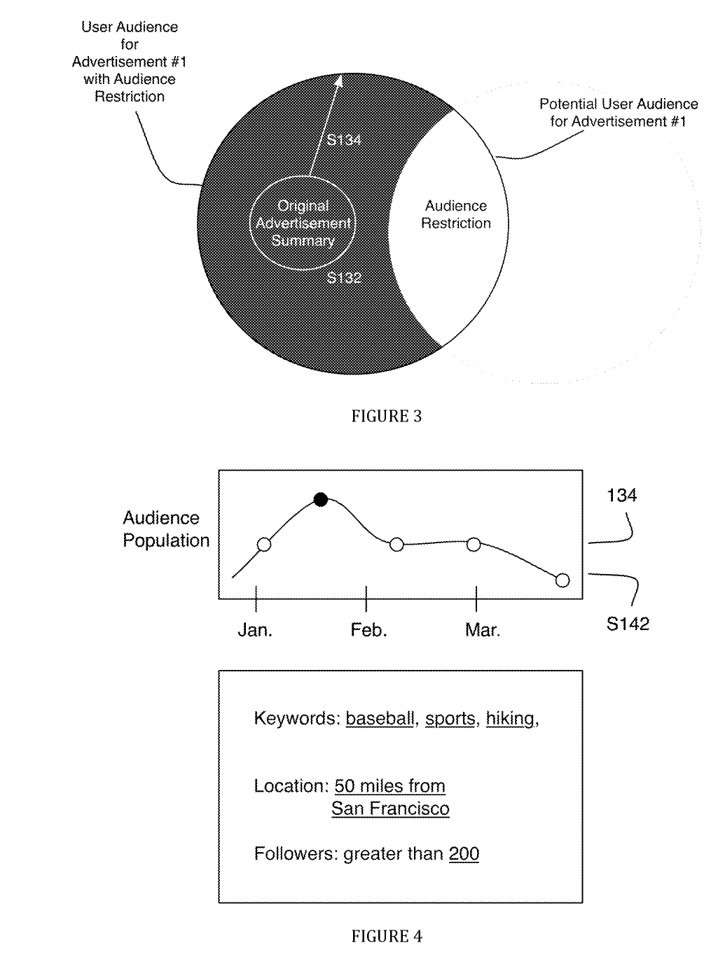

Step 130, which includes the step of selecting a user audience based in the target audience, functions to generate an advertisement summary that defines a user audience of substantially the target audience size. As shown in FIG. 3, Step 130 preferably includes the iterative sub-steps of identifying a user audience that satisfies the advertisement summary S132 and adjusting the advertisement summary S134.

The step of identifying a user audience that satisfies the advertisement summary S132 functions to determine which the users that are included in the user audience and the size of the user audience. Preferably, users with user summaries that substantially match the keywords and keyword affiliation weight selections of the advertisement summary are included in the user audience. However, users may not need to match the advertisement summary exactly to be included in the user audience. For example, the user may be included in the user audience if the user only shares keywords that have a high importance weight in the advertisement summary (wherein the keyword importance weight is determined to be “high” if it is over a predetermined threshold). In another example, the user may be included if their user summary includes a related keyword to a high importance weighted keyword. To determine how closely the user summaries match with the advertisement summary, this step preferably includes calculating a similarity score between each user summary and the advertisement summary, wherein the user is included in the user audience if the similarity score is above a predetermined threshold. However, this step may alternately calculate a similarity score between a persona and an advertisement summary, wherein all the users that are associated with the persona are deemed included in the user audience. This step may alternately use any other method of determining whether a user matches the advertisement summary. This step also determines the user audience size, which is the number of users in the user audience.

The step of adjusting the advertisement summary S134 functions to generate an advertisement summary associated with a user audience substantially the same size as the target audience size. The advertisement summary is preferably adjusted by abstracting or narrowing keywords, increasing or decreasing keyword importance weightings, and/or selecting a higher or lower keyword affiliation weight, which functions to expand or contract the user audience. Keywords are preferably adjusted (e.g. abstracted or narrowed) based on predetermined relationships between keywords, such as those described in standard keyword groups or in hierarchy trees. For example, a keyword is abstracted by replacing it with a hierarchically superior keyword (e.g. “baseball” becomes “sports,” “San Francisco” becomes “California,” or “10,000 followers” becomes “1,000” followers), and narrowed by adding one or more hierarchically subordinate keywords. Adding peer keywords, adding unrelated keywords, or removing keywords from the advertisement summary may additionally adjust the advertisement summary.

The step of adjusting the advertisement summary S134 may additionally account for an audience restriction, which functions to limit which users that may be included in the user audience. Accounting for an audience restriction may be desirable if a persona or population of users is desired to be reserved (e.g. for another advertisement, or when the advertiser had not bid for those users). Audience restrictions may be applied by a second advertisement (e.g. high importance weighted keywords from the advertisement summary), by the operator of the method, or by any suitable means. The audience restriction is preferably a user attribute, wherein users with the attribute are excluded from the user audience. In one embodiment, the audience restriction is an affiliation weight threshold, wherein users with a keyword affiliation weight higher or lower than the threshold are excluded from the user audience. For example, influencers for a certain topic (e.g. users with a high topic or keyword affiliation weighting) may be excluded by restricting users with a keyword affiliation weighting higher than the threshold. In a second embodiment, the audience restriction is a persona restriction, wherein the users affiliated with a certain persona (e.g. Mac users, high click-through users, influencers) are excluded from the user audience. Alternately, the persona restriction may limit the advertisement summary to only expand and contract within a limited number of persona. In a third embodiment, the audience restriction is a keyword restriction, wherein users with the keyword in their user summaries are excluded from the user audience. In a fourth embodiment, the audience restriction is an importance weight threshold, wherein the advertisement summary is restricted from adjusting a keyword above or below the threshold. This step preferably applies a combination of the aforementioned audience restrictions to restrict an advertisement summary, but may alternately apply one, none, or any other audience restriction to the advertisement summary. The audience restriction is preferably applied by restricting the advertisement summary from including the restricted attribute during advertisement summary adjustment, but may alternately restrict the advertisement summary from including users with the restricted attribute or removing users satisfying the audience restriction from the user audience after determining an initial adjusted advertisement summary. In the latter case, a second adjustment would be performed to compensate for the removal of users from the user audience.

Step 130 is preferably performed by a scaling engine, wherein the scaling engine determines the optimal adjustments of the keywords to generate an advertisement summary for a given target audience size. The scaling engine preferably determines which keywords to adjust through an optimization program, but may alternately determine the optimal summary by iterating through all combinations of related keywords, iterating through all combinations of all keywords, pre-calculating common personas, or using any other suitable means of determining a summary that addresses the desired target audience size. Keywords may be adjusted according to hierarchical tree grouping, semantic keyword grouping (e.g. Google Sets), or by utilizing any other suitable keyword relationship. Additionally, the scaling engine preferably takes into account the keyword importance weightings when adjusting the keywords. Step 130 may alternately be performed multiple times for a range of target audience sizes, and may be performed in real time or before a target audience size is received.

Step 140, which includes assigning and prioritizing the advertisement for a user of the user audience, functions to associate the advertisement with a user as well as to determine the serving priority of the advertisement to the user. The advertisement is preferably associated with the user to ensure that the advertisement is served, thus meeting the target audience size. The advertisement is preferably prioritized relative to other advertisements to ensure that user preferences are met, and that advertisements are served within the timeframe of their campaign. Assigning the advertisement to a user of the user audience S142 preferably includes adding the advertisement to an advertisement queue associated with the user, but may alternately include any other method of associating the advertisement with the user. Prioritizing the advertisement relative to the other advertisements associated with the user S144 preferably includes ranking the advertisements in serving order. The queued advertisements are preferably ranked according to the user's preferences, as determined from the associated user summary, but may alternately/additionally be ranked according to an advertisement priority. The advertisement priority is preferably determined from the urgency of the campaign (e.g. the amount of impressions left to serve and the amount of time left in the campaign), but may alternately be determined from the amount an advertiser has bid for priority or any other suitable metric. The advertisement priority is preferably determined without accounting for any users.

Step S150, which includes serving a user-associated advertisement to the user, functions to serve advertisements to users that fit the persona as defined by the selected vector parameters. The advertisement is preferably served in a social network environment, more preferably in connection with a content stream. The advertisement may alternatively be served in any suitable environment, such as a website with social network integration. The advertisement is preferably served in response to an advertisement request associated with the user. The top-ranked advertisement from the user-associated advertisement queue is preferably served, after which the served advertisement is preferably removed from the queue.

As an additional step, the method may additionally include scheduling vector parameters S152, which functions to plan a dynamic campaign over time. Expected target audience sizes can preferably be set for a future time. A graph representing a timeline of an advertisement campaign preferably allows points to be defined based on the expected user audience, as shown in FIG. 4. The set of vector parameters are preferably set so that at any given time, the user audience coincides with that of the timeline. Step S132 enables advertisers to plan campaign ramp ups, weekly scheduling, and employ any suitable time-based strategy. Additionally, the amount of money spent on advertising can preferably be managed more efficiently by fine-tuning an advertisement plan.

In this method, steps S130 and S140 may additionally be repeated in response to a system change, and functions to reallocate users/user impressions to most optimally satisfy advertisement campaign requirements and user preferences. System changes include the inclusion of a new advertisement, the addition of a new user, the update of a user summary, or any other suitable change.

### 2. System for Scaling Persona Targeted Advertisements

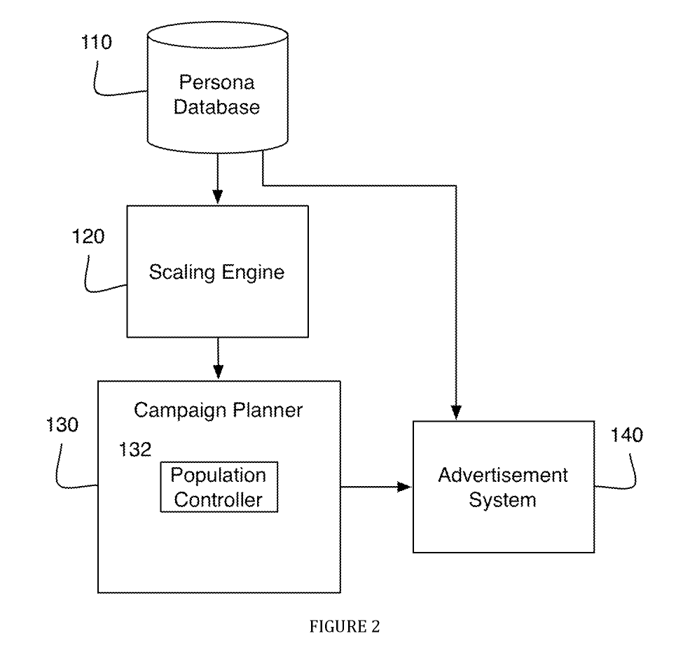

As shown in FIG. 2, a system for scaling persona targeted advertisements preferably includes a persona database 110, a scaling engine 120, campaign planner user interface 130, and an advertisement system 140. The system functions to distribute user impressions amongst a plurality of advertisements to optimally satisfy both advertisement campaign requirements and user preferences. The system is preferably used within a social network ecosystem where a persona of a user may be analyzed or alternatively may be utilized (such as a website with social network integration). The system is preferably used for advertising to users that can be related to a persona, but may alternatively be used as form of feedback to advertisers on who they are targeting based on particular parameters.

The persona database no functions as a repository of user characterization information. The persona database no preferably includes a persona characterization for a plurality of users. The persona database no may be actively updated database of a substantial number of users of a social network ecosystem or users of interest. Alternatively, the persona database 110 may be a sampling of users for estimating the audience. A persona of a user is preferably generated from a social network content stream of a user. A variety of aspects of a user account on a social network content stream are preferably analyzed to generate a persona including, a user profile, posted content, metadata of posted content such as location, followed users, following users, and any suitable aspect of the user account. The persona of a user is preferably defined with various weighted parameters and/or keywords. The parameters are preferably keywords that contribute to the understood definition of a persona. The persona database 110 also preferably stores a list of advertisements associated with the each user in the persona database.

The scaling engine 120 functions to select a user audience for each of the plurality of advertisements by adjusting the advertisement summaries. The scaling engine preferably identifies a suitably sized user audience for an advertisement by determining the similarity between the user summaries and the advertisement summary, adjusting the advertisement summary based on the target size and an audience restriction, and assigning the advertisement to each user of the user audience. In identifying the user audience, the scaling engine preferably calculates a similarity score between the user summary and the advertisement summary, and includes users with a similarity score higher than a predetermined similarity threshold. To adjust the advertisement summary, the scaling engine preferably increases or decreases keyword importance weightings and/or keyword affiliation weightings, or adjusts the keywords themselves by abstracting, narrowing, adding, or removing keywords from the advertisement summary. The scaling engine preferably assigns an advertisement to a user by adding the advertisement to the user-associated advertisement list, but may alternately assign a list of users to the advertisement or utilize any suitable method of associating a user with an advertisement. The scaling engine may additionally prioritize the advertisement list according to user preferences and/or advertisement priority (relative to other advertisements).

The campaign planner 130 user interface functions to allow for advertiser interaction with the advertisement summary. The campaign planner 130 preferably includes input fields for a user (e.g., an advertiser) to supply the system with an initial target persona. The target persona is preferably supplied by inputting the keywords of the advertisement summary substantially manually. As an alternative, the target persona may be generated automatically from other sources. For example, the advertiser may select a model user or a plurality of model users. Keywords or attributes are preferably extracted based on the selected model user. Information of a plurality of model users is preferably averaged, additively merged, or combined in any suitable manner. The campaign planner 130 preferably additionally includes an audience size controller 132. The audience size controller 132 is preferably a text field, but may alternatively be a slider, a selectable menu, multidimensional plot (such as the schedule planner described below), or any suitable interface. The audience size controller 132 preferably enables a user to adjust the expected audience size of a persona. The audience size controller 132 is preferably a simple device for tuning an advertisement summary. By adjusting the audience size, the advertisement summary is preferably changed to satisfy the audience size stipulated by the audience size controller 132. The user audience generated by the scaling engine 120 is preferably used as the model for translating the audience size controller 132 to a advertisement summary variations of a persona. As shown in FIG. 4, the audience controller 132 may additionally or alternatively include a schedule planner 134 that functions to allow for the advertisement summary to be dynamically adjusted over time. The schedule planner is preferably a graph with a time axis and an expected audience axis. A plurality of target points can preferably be configured so that expected audience sizes are preferably met at particular times. In between target points, the keywords of the advertisement summary are preferably interpolated to approximate values for transitioning between two target points. The campaign planner 130 may additionally include a keyword display that functions to reflect the resulting advertisement summary after using the audience controller 132. The display preferably reflects the advertisement summary that will be used for an audience size setting of the audience size controller 132. The campaign planner 130 may additionally include a keyword editor, which preferably functions to allow keywords to be modified. The keyword editor is preferably integrated with the display. Keywords can additionally be locked and/or importance weighted. Locking a keyword preferably causes the scaling engine to include users that substantially match the keyword. Weighting a keyword preferably biases the scaling engine to avoid diverging from the input parameter (e.g., if weighted as important) or more liberally diverging from the input parameter (e.g., if weighted as less important).

The advertisement system 140 functions to serve an advertisement into an advertising space for a user. The advertising space is preferably the same space from which the persona database was collected, but may alternatively be related space (such as a website with a social network integration). The advertisement system receives an advertisement request linked to a user, preferably from the advertising space, and serves an advertisement in response. The advertisement served is preferably from the user advertisement queue, more preferably the highest prioritized advertisement in the user queue. The advertisement system 140 preferably removes the advertisement from the user queue after the advertisement is served.

An alternative embodiment preferably implements the above methods in a computer-readable medium storing computer-readable instructions. The instructions are preferably executed by computer-executable components integrated with a social network, content steam, and/or any suitable website suitable for persona based advertising. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for allocating an advertisement from a plurality of advertisements to a plurality of users within a social network ecosystem, each user associated with a user queue and a user summary including a keyword describing a user attribute extracted from the social network, the method comprising the steps of:
at a processor, selecting a user audience for each of the plurality of advertisements from the plurality of users, including the steps of:
receiving an advertisement summary for an advertisement, the advertisement summary including a plurality of importance weighted keywords;
receiving a target audience size for the advertisement;
identifying a dissimilarity between a first user audience size associated with the advertisement summary and the target audience size;
in response to the dissimilarity, altering the advertisement summary based on the target audience size and an audience restriction, the altered advertisement summary associated with a second user audience of the target audience size; and
assigning the advertisement to the user queues associated with each user of the user audience, each user queue comprising the advertisements to be served to the user;
at the processor, prioritizing the advertisements in the user queue of a user of the user audience based on the associated user summary;
at the processor, automatically serving a highest priority advertisement from the user queue in response to a receipt of a request for the user; and
removing the served advertisement from the user queue.

2. The method of claim 1, wherein identifying the dissimilarity between the user audience size associated with the advertisement summary and the target audience size further comprises identifying, from the plurality of users, a user audience that satisfies the advertisement summary.

3. The method of claim 2, wherein the step of identifying a user audience includes calculating a similarity score between a user summary and the advertisement summary, wherein the user associated with the user summary is included in the user audience when the similarity score is above a predetermined threshold.

4. The method of claim 2, wherein the step of identifying a user audience includes identifying a user with a user summary that includes an advertisement summary keyword with a high importance weighting.

5. The method of claim 4, wherein the keywords of the user summaries are affiliation weighted keywords and the advertisement summary further includes a keyword affiliation weight selection for a keyword, wherein the step of identifying a user audience includes identifying a user associated with a user summary that includes the advertisement summary keyword with a keyword affiliation weight equal to or higher than the keyword affiliation weight selection.

6. The method of claim 1, wherein the advertisement summary is altered based on the target audience size by abstracting a keyword to a hierarchically superior keyword.

7. The method of claim 1, wherein the advertisement summary is altered based on the target audience size and an audience restriction by decreasing the keyword importance weight.

8. The method of claim 1, wherein the keywords of the user summaries are affiliation weighted keywords and the advertisement summary further includes a keyword affiliation weight selection for a keyword, the advertisement summary altered based on the target audience size by lowering a keyword affiliation weight selection.

9. The method of claim 1, wherein the audience restriction includes a keyword restriction.

10. The method of claim 9, wherein the keywords of the user summaries are affiliation weighted keywords and the advertisement summary includes a keyword affiliation weight selection, the keyword restriction including restricting the keyword affiliation weight selection.

11. The method of claim 10, wherein the keyword affiliation weight selection restriction is an affiliation weight threshold, the associated user audience excluding users with a keyword affiliation weighting higher than the affiliation weight threshold.

12. The method of claim 11, wherein the keyword restriction is determined from a second advertisement of the plurality of advertisements.

13. The method of claim 12, wherein the keyword affiliation weight threshold is equal to the keyword affiliation weight selection of a keyword with a high importance weighting from the advertisement summary of the second advertisement.

14. The method of claim 11, wherein the audience restriction includes a persona restriction that includes a set of keyword restrictions, the set of keyword restrictions comprising a set of affiliation weight thresholds, each affiliation weight threshold being associated with a keyword.

15. The method of claim 9, wherein the keyword restriction includes restricting the importance weighting of a keyword.

16. The method of claim 15, wherein the importance weighting restriction is an importance weight threshold, the advertisement summary being restricted from adjusting the keyword importance weighting above the importance weight threshold.

17. The method of claim 9, wherein the audience restriction is generated from a second advertisement summary associated with a second advertisement of the plurality of advertisements.

18. The method of claim 17, wherein keyword restriction in the first advertisement summary includes excluding a keyword included in the second advertisement summary with a high importance weighting.

19. The method of claim 1, wherein the highest prioritized advertisement is served from the advertisement queue.

20. The method of claim 19, wherein prioritizing the advertisements in the advertisement queue is further based on an advertisement priority for each of the queued advertisements, the advertisement priority being relative to other advertisements and is determined based on one or more metrics selected from the group consisting of: time left in a campaign associated with the advertisement, revenue generated from each impression of the advertisement, and number of impressions left to be served in a campaign associated with the advertisement.

21. A system for distributing user impressions to a plurality of advertisements within a social network comprising a plurality of users, the system comprising:
a processor;
a persona database associated with if the processor that stores a plurality of user summaries, each user summary comprising a user attribute extracted from the social network, and a plurality of user summary-associated user advertisement lists, each list comprising a prioritized list of advertisements, each user summary and associated user advertisement list associated with a user of the social network, each user of the social network further associated with an advertisement list specific to the user;
a scaling engine operable within the processor that:
identifies a user audience for an advertisement by determining a similarity score between an advertisement summary associated with the advertisement, the advertisement summary comprising an attribute selection, and each of the user summaries in the persona database, wherein a user is included in the user audience if the similarity score is above a predetermined similarity threshold, the user audience comprising a user audience size;
in response to determination of a dissimilarity between the user audience size and a target audience size, adjusts the advertisement summary based on the target audience size and an audience restriction to generate a secondary advertisement summary associated with a second user audience that meets the target audience size;
assigns the advertisement to the user advertisement list of each user of the second user audience; and
prioritizes each user advertisement list based on the associated user summary;
a campaign planner user interface connected to the processor that receives the advertisement summary and the target audience size; and
an advertisement system operable within the processor that:
receives an advertisement request for a user;
serves the highest prioritized advertisement from the user advertisement list associated with the user; and
removes the served advertisement from the user advertisement list.

22. The system of claim 21, wherein the user summary comprises an affiliation weighted attribute and the advertisement summary further includes an attribute affiliation weight selection, the scaling engine adjusting the affiliation weight selection to adjust the advertisement summary.

23. The system of claim 22, wherein the restriction is an attribute affiliation weight threshold, and wherein the scaling engine excludes, from the user audience, users associated with user summaries that include an affiliation weight for the attribute greater than the affiliation weight threshold.
